(19) United States
(12) Patent Application Publication
(10) Pub. No.: US 2013/0188218 A1
(43) Pub. Date: Jul. 25, 2013

(54) Print Requests Including Event Data

(71) Applicant: Bhatia Rajesh, Bangalore (IN)

(72) Inventor: Bhatia Rajesh, Bangalore (IN)

(21) Appl. No.: 13/354,128

(22) Filed: Jan. 19, 2012

(51) Int. Cl. G06K 15/02

(52) U.S. Cl. 358/1.15

(57) ABSTRACT

A print request can include event data. The event data can be based on a user's input.

### BACKGROUND

People often use computing devices, such as mobile phones and tablet computers, to create and edit various types of electronic documents. Various computer applications running on the computing devices can be used to create and edit the electronic documents. Electronic documents may represent text, photographs, graphic designs, and the like. These electronic documents are often sent to a printing device to be printed onto paper or another type of print medium. Additionally, user interfaces on printers are sometimes used to set print settings for a document to be printed.

Manufacturers of computing devices and printers as well as providers of print services are challenged with providing satisfying user experiences. For example, improving the ease of use of their devices and services may be desirable.

### BRIEF DESCRIPTION OF DRAWINGS

The following detailed description refers to the drawings, wherein:

FIG. 1 is a block diagram illustrating a computing device including a display, a sensor, and a controller for generating a print request, according to an example.

FIGS. 2(a)-2(b) depict a sample use case in which a computing device is rotated to cause an orientation change, according to an example.

FIG. 3 is a depiction of a sample use case involving a pinch-to-zoom multi-touch gesture, according to an example.

FIG. 4 is a depiction of a sample use case involving a drag-and-drop gesture, according to an example.

FIG. 5 is a flowchart illustrating aspects of a method for generating a print request, according to an example.

FIG. 6 is a block diagram illustrating a computer including a machine-readable storage medium encoded with instructions to generate a print request, according to an example.

FIG. 7 is a block diagram illustrating a printer including a display, a user interface, and a communication interface, according to an example.

### DETAILED DESCRIPTION

Manufacturers of computing devices and printers and providers of printer services are challenged with providing satisfying user experiences. Improving the ease of use of these devices may be desirable.

For example, many computing devices, such as tablet computers and smart phones, have various user input capabilities. For instance, many computing devices have touch and multi-touch input capabilities, allowing for input gestures like pinch-to-zoom. Additionally, orientation changes of a viewed document or image can often be accomplished simply by rotating the computing device approximately 90 degrees (e.g., by rotating from a portrait orientation to a landscape orientation). These inputs may be provided to a user application running on the computing device. The user application may modify the display of documents and image data based on these inputs. For instance, a portion of a picture may be zoomed-in on a display of the computing device based on a pinch-to-zoom gesture. However, these inputs tend to only affect how the image is displayed and may not modify the document or image data itself or affect how it is printed.

According to some examples disclosed herein, event data relating to these inputs can be included in a print request along with the original (i.e., unmodified by the event data) image data. The print request can be sent to a computer, which may be a cloud computer, such as a server used in a cloud-printing system. The computer may modify the image data based on the event data and generate print data. The print data may in turn be sent to a printer for printing. Accordingly, a document may be printed which reflects changes or edits based on the user's input to the user application. This can be done without the user setting print attributes corresponding to the changes or edits and without the computing device sending modified image data. The user may thus achieve a helpful degree of control over what is printed in an easy, intuitive manner.

In addition, according to some examples disclosed herein, a printer in a cloud-printing system may have a display and user interface capable of receiving multi-touch input. For instance, the printer may have a touch screen display. A preview of a document to be printed may be displayed on the display. The user may make rough-cut edits of the document using the user interface. For instance, the user may zoom in on a portion of the document using a pinch-to-zoom gesture. Event data relating to the user's input can be included in a print request to a computer, such as a cloud computer. Image data corresponding to the document to be printed may be included in the print request. Alternatively, the computer may already have the image data corresponding to the document stored therein. The computer may modify image data based on the event data and generate print data. The computer may send the print data to the printer. After receiving the print data, the printer may display the print data on the display. If the print data looks acceptable, the user may cause the printer to print the document. Accordingly, multi-touch inputs entered into a user interface of a cloud-enabled printer may be processed on the cloud and a document can be printed including edits or changes based on the multi-touch inputs. This can provide the user with beneficial control and versatility over what is printed without the printer having to include expensive processing hardware.

The above examples are merely intended to illustrate a few features and advantages of some embodiments relating to the claimed subject matter. Further details of these embodiments and associated advantages, as well as of other embodiments and applications, will be discussed in more detail below with reference to the drawings.

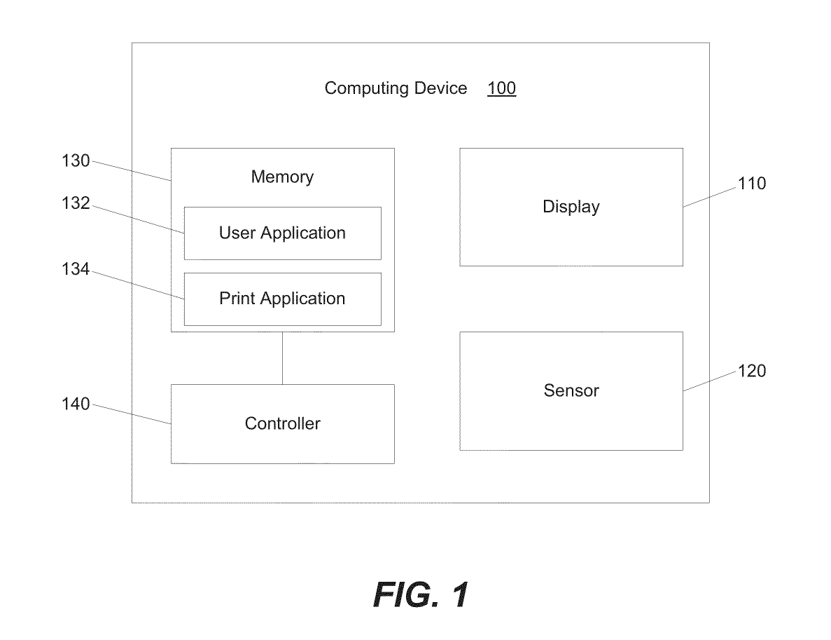

Referring now to the drawings, FIG. 1 is a block diagram illustrating an embodiment of a computing device 100 including a display 110, a sensor, 120, a memory 130, and a controller 140. Computing device 100 may be any of a variety of computing devices. For example, computing device 100 may be a tablet or slate computer, a laptop computer, a desktop computer, a cellular telephone, or a smart phone, among others.

Computing device 100 may include a display. Display 110 may be any of various display screens. For example, the display may be a display integrated into computing device 100, such as in the case of tablet computers and all-in-one computers. The display may also be a display remotely connected to computing device 100, such as a LCD monitor. Furthermore, the display may be a touch sensitive display. Display 110 may be used for various purposes, such as to display a user interface, text, images, and movies.

Computer device 100 may include a sensor. Sensor 120 may be any of various sensors. For example, sensor 120 may include touch sensors, such as capacitive touch sensors. Sensor 120 may be integrated into display 110 to provide a touch sensitive display.

Sensor 120 may be used to receive input from a user. For example, sensor 120 may receive a multi-touch input. A multi-touch input may comprise various gestures. For instance, a pinch or spread gesture of two fingers (referred to herein as “pinch-to-zoom”) may be used to indicate a zoom command. In addition, other gestures may be sensed by sensor 120. For instance, a drag-and-drop gesture may be used in which a finger is used to select an item at a first location on a sensor surface of sensor 120, drag it across the sensor surface, and drop it on a second location of the sensor surface.

Sensor 120 may also be capable of sensing an orientation of computing device 100 and/or display 110. For example, sensor 120 may include an accelerometer, a gravitometer, or the like. If computing device 100 is rotated, sensor 120 may determine which direction computing device 100 has been rotated and by how much. Accordingly, sensor 120 can be used to determine a current orientation of computing device 100. For instance, a computing device having a rectangular shape, as many tablet computers and smart phones have, may have a portrait orientation and a landscape orientation which may be detected using sensor 120.

Computing device 100 may include memory 130, such as a machine-readable storage medium. The machine-readable storage medium may be any electronic, magnetic, optical, or other physical storage device that contains or stores executable instructions. Thus, the machine-readable storage medium may comprise, for example, various Random Access Memory (RAM), Read Only Memory (ROM), flash memory, and combinations thereof. For example, the machine-readable medium may include a Non-Volatile Random Access Memory (NVRAM), an Electrically Erasable Programmable Read-Only Memory (EEPROM), a storage drive, a NAND flash memory, and the like. Further, the machine-readable storage medium can be computer-readable and non-transitory. Memory 130 may store various data and computer programs. For example, memory 130 may store user application 132 and print application 134.

User application 132 may be any of various computer applications. For example, user application 132 may be a word processing application, a document viewing application, or a photo viewer application. User application 132 may be used to view, edit, or modify various data, such as image data. Image data may include text, images, photos, and the like. User application 132 may display the image data on display 110. User application 132 may also receive inputs from a user via sensor 120.

Print application 134 may be any of various print applications. For example, print application 134 may enable printing in a cloud-printing system. For instance, print application 134 may send a print request to a remote computer on the Internet. The remote computer may in turn process the print request and send print data to a particular printer. The printer may be part of a cloud-printing system. For instance, the printer may be located in a home, an office, or a store and may have a connection to various computers via the Internet. The printer may be capable of sending and receiving data and instructions.

Print application 134 may be constantly running on computing device 100. For example, print application 134 may run in the background so that it is available to enable printing whenever computing device 100 is in an on state. Alternatively, print application 134 may be available only when it is directly accessed or when user application 132 is being used. In some examples, a virtual button (such as a button that may be selected via a touch screen) may enable commands to be input to print application 134. The virtual button may be displayed on display 110 while user application 132 is displayed. For example, when a user interface of user application 132 is displayed, a virtual button corresponding to print application 134 may be displayed in a corner of the screen. For example, the virtual button may be a print button. Functionality of print application 134 may be made available to the user during use of user application 132 in other ways as well, such as through a menu or through a certain predefined input (such as a particular multi-touch gesture).

Computing device 100 may include controller 140. Controller 140 may include a processor and a memory for executing user application 132 and print application 134. The memory may be any of various machine-readable storage mediums, such as described with respect to memory 130. The processor may include at least one central processing unit (CPU), at least one semiconductor-based microprocessor, at least one digital signal processor (DSP) such as a digital image processing unit, other hardware devices or processing elements suitable to retrieve and execute instructions stored in memory, or combinations thereof. The processor can include single or multiple cores on a chip, multiple cores across multiple chips, multiple cores across multiple devices, or combinations thereof. The processor may fetch, decode, and execute instructions from memory to perform various functions, such as generating, processing, and transmitting image data. As an alternative or in addition to retrieving and executing instructions, the processor may include at least one integrated circuit (IC), other control logic, other electronic circuits, or combinations thereof that include a number of electronic components for performing various tasks or functions.

In one example, display 110 can display image data from user application 132. For example, the image data may represent a photo. The image data may be considered original image data when it has not been modified by a subsequent input.

Sensor 120 may receive an input for user application 132 from a user. For example, the user may use a pinch-to-zoom gesture to zoom-in on a portion of the image data. Sensor 120 can detect the pinch-to-zoom gesture and generate event data based on the gesture. In one example, the event data may comprise coordinates corresponding to the zoomed-in portion of the image data. For instance, a sensor surface of sensor 120 may be mapped to a bitmap representing the image data displayed on display 110. The input pinch-to-zoom gesture may thus be used to determine coordinates on the bitmap corresponding to a zoomed-in portion of the image data.

User application 132 can make a modification to the displayed image data based on the event data. For example, user application 132 can cause display 110 to display a zoomed-in portion of the image data corresponding to the coordinates. The modification may be made to the displayed image data without actually changing the image data itself. As mentioned previously, this unmodified image data may be considered original image data. For example, the image data may be stored the same way in memory even after the modification. The modification to the displayed image data may be implemented based on communication between user application 132 and display 110.

Print application 134 can send a print request to another computer. The print request may include information relating to the users input (e.g., a print-to-zoom gesture input). Print application 134 may send the print request in response to a print instruction from the user. For example, the user may input the print instruction via a virtual print button or the like made available on the user interface of the user application 132. The print instruction may constitute a simple one-click input, such that the user does not enter any print settings or attributes. For example, print settings or attributes corresponding to the event data and/or the modification associated with the event data may not be specified by the user. Certain settings or attributes, however, may be pre-specified by the user or the application creator as default settings or the like. Additionally, a particular printer that the user would like to print to may be stored as a default setting in association with the print button. Alternatively, a dialog box may be opened after selecting the print button to specify which printer the user would like to print to.

Computing device 100 may send the print request via a communication interface. The communication interface may include, for example, a transmitter that may convert electronic signals to radio frequency (RF) signals and/or a receiver that may convert RF signals to electronic signals. Alternatively, the communication interface may include a transceiver to perform functions of both the transmitter and receiver. The communication interface may further include or connect to an antenna assembly to transmit and receive the RF signals over the air. The communication interface may communicate with a network, such as a wireless network, a cellular network, a local area network, a wide area network, a telephone network, an intranet, the Internet, or a combination thereof. Additionally, the communication interface may include an Ethernet connection or other direct connection to a network.

A print request may be a request to generate print data. The print request may include the original image data and the event data for the user application. The original image data may correspond to the image data without modification. For example, where the modification constitutes a zooming-in of the image data due to a pinch-to-zoom gesture, the original image data may correspond to the un-zoomed image data. The print request may be considered to be a request to generate print data representing the original image data with the modification. Accordingly, instead of computing device 100 having to generate image data with the modification and send that modified image data to the computer, the computer may process the event data and modify the image data accordingly.

The computer to which the print request can be sent may be a computer in a cloud-printing system. A cloud-printing system can be a system in which one or more computers connected to the Internet operate as a server for receiving print requests from one or more computing devices or printers, generating print data based on the print requests, and sending the print data to a printer for printing. Accordingly, in a cloud-printing system a computing device may cause a printer to print a document without communicating directly with the printer. The computer may include a processor, memory, and a communication interface, among other features.

The computer may process the print request. For example, the computer may interpret the event data in the print request and modify the original image data based on the event data. For instance, if the event data contains coordinates corresponding to a pinch-to-zoom multi-touch gesture, the computer may zoom-in on the image data. The computer may generate print data based on the modified image data. In some cases, zooming-in on the image data and generating print data may be a single step. For example, the computer may simply generate print data corresponding to the image data within the coordinates specified by the event data. In generating print data, the computer may rasterize the image data to create print data suitable for printing on a printer. Additionally, the print request may specify a particular printer that the print data is to be sent to. Accordingly, the computer may generate the print data according to a format appropriate for the specified printer. The computer may then send the print data to the specified printer for printing. The printer may print the print data as a document. Accordingly, a document corresponding to the image data with the modification may be printed.

In some cases, a user may perform a series of inputs before printing a document or image. For instance, the user may first reorient the computing device (from portrait to landscape, for example) and then zoom-in using a pinch-to-zoom gesture input. In such a case according to one example, the print application may log all of the event data relating to these inputs and include the event data in the print request. Then, the computer receiving the print request may follow the sequence of event data to generate print data corresponding to the final displayed image (i.e., the image that resulted from the various inputs).

Computing device 100 and/or the cloud-printing system may include additional components and features as well, beyond those depicted in FIG. 1 and described above.

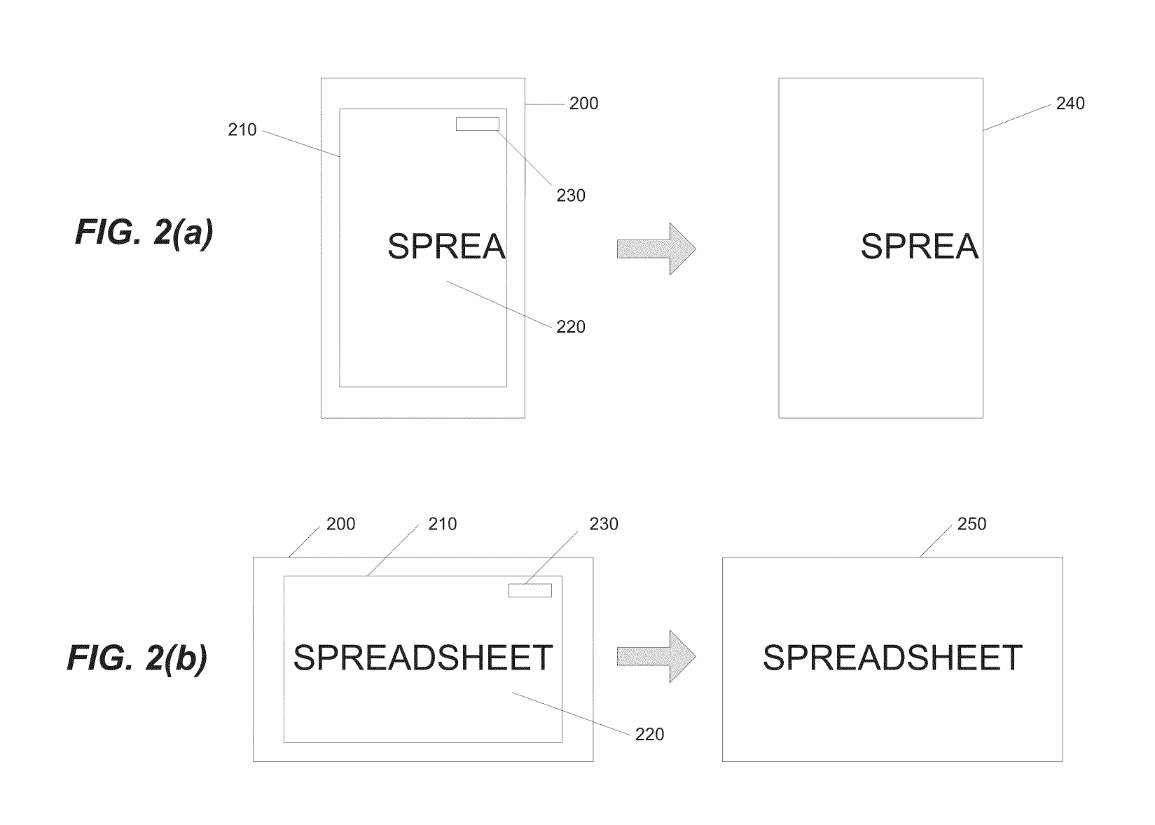

FIGS. 2(a)-2(b) depict a sample use case relating to devices and methods disclosed herein, according to an example. Tablet computer 200 includes a display screen 210. A document 220 is displayed on the display screen. Document 220 may be a document displayed by a user application running on tablet computer 200. Print button 230 is a virtual button that may be pressed to cause document 220 to be printed. For example, pressing print button 230 may activate a print application to send a print request to a cloud-computing system.

In FIG. 2(a), tablet computer 200 and display 210 are in a portrait orientation. Document 220 contains the text “SPREADSHEET” which is not fully displayed while the display is in portrait orientation. It is assumed that document 220 is stored in memory in portrait orientation. While this example has been simplified for illustration purposes, document 220 may be an actual spreadsheet which contains so many columns that the entire width of the document is not viewable in a portrait view. Furthermore, it is assumed in this example that the view of document 220 on display 210 represents a single printable page. Accordingly, if the user presses print button 230, document 240 may be printed as a result. For example, the print application may send image data corresponding to document 220 to a cloud-computing system for printing. Since document 220 is stored in memory in portrait orientation, the image data sent to the cloud-computing system is also in portrait orientation. The cloud-computing system then generates print data corresponding to document 220 in portrait orientation. As can be seen, document 240 is printed in portrait orientation and the text “SPREADSHEET” is cut off on the document in the same way that it is cut off on display 210.

In FIG. 2(b), tablet computer 200 and display 210 are in a landscape orientation. For example, a user may have rotated the tablet computer 90 degrees so that he could view all of the text. Upon rotating the tablet, a sensor within the tablet may detect the rotation and send event data to the user application indicating that the tablet has been rotated. As a result, the user application may in turn rotate document 220 to landscape orientation for displaying on display 210. As can be seen, when document 220 is in landscape orientation the entire text of “SPREADSHEET” is able to fit onto the screen. If the user presses print button 230, document 250 may be printed as a result. For example, the print application may send image data corresponding to document 220 as well as the event data corresponding to the orientation change to a cloud-computing system. The cloud-computing system can interpret the event data and generate print data corresponding to document 220 in landscape orientation. Document 250 may then be printed in landscape orientation and the text “SPREADSHEET” is fully viewable. Accordingly, document 250 may be printed in landscape orientation without the user having to explicitly set within the user application a document attribute of document 220 as landscape, and without having to specify within the print application a printer setting or attribute as landscape.

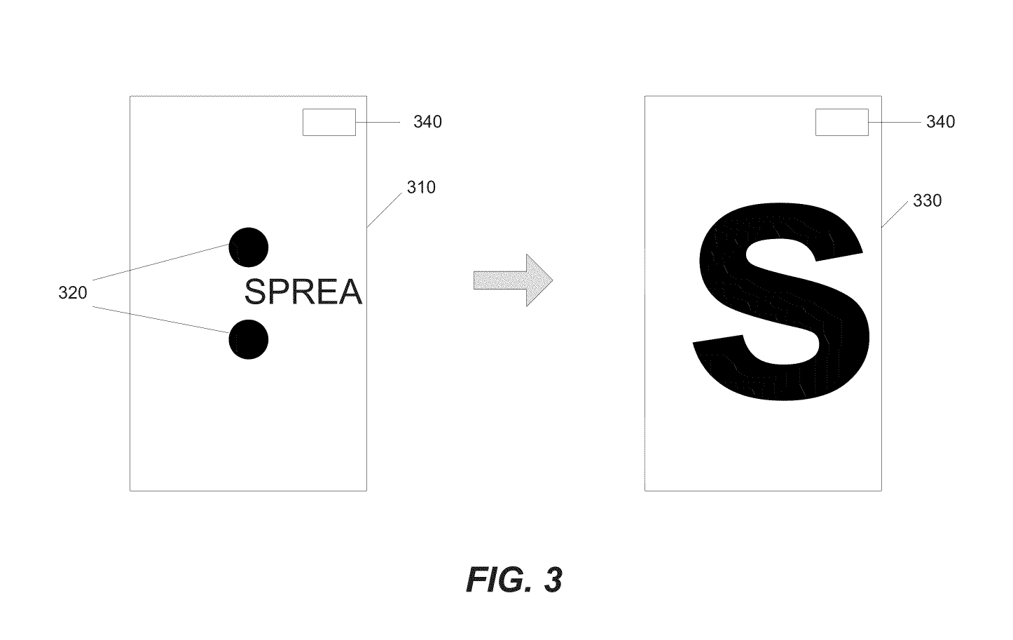

FIG. 3 depicts a sample use case relating to devices and methods disclosed herein, according to an example. Image 310 represents a view of image data displayed by a user application on a touch-sensitive display of a computing device. Image 310 includes the letters “SPREA”. Black marks 320 represent the placement of a user's thumb and pointer finger on the touch-sensitive display. It is assumed that the user spreads his thumb and pointer finger so as to zoom-in on the image. Event data including the coordinates associated with the user's input may be passed to the user application. The user application may process the event data and cause the display to display a zoomed-in portion of the image data. Image 330 represents a view of the zoomed-in portion of image data on the display. If the user activates the print button 340 when viewing image 330, a print application may generate a print request including the event data and image data corresponding to image 310. The print application may send the print request to a cloud-computing system for printing. The cloud-computing system may generate print data based on the image data and event data that corresponds to image 330 and may send the generated print data to a printer to be printed. Accordingly, a document representing zoomed-in image 330 may be printed based on the user's input to the user application.

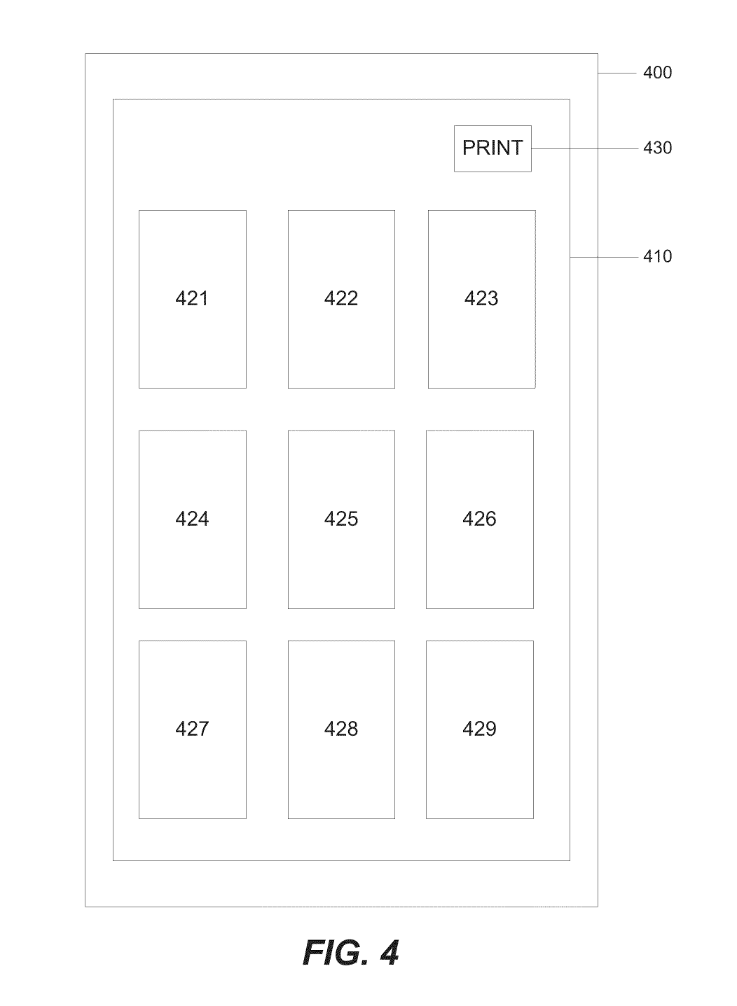

FIG. 4 depicts a sample use case relating to devices and methods disclosed herein, according to an example. Tablet computer 400 includes a display 410. A user application running on tablet computer 400 may display a group of photos 421-429. A print button 430 can be used to send a print request to a cloud-computing system. The print button 430 may also serve as a canvas for creating a collage of photos. A user may drag and drop a series of photos 421-429 onto print button 430 to create a collage. For example, the user may individually drag and drop photos 421, 424, 425, and 429 onto print button 430. The user may then press print button 430. A print application may generate a print request including image data corresponding to photos 421, 424, 425, and 429 along with the drag and drop event data. The print application may send the print request to a cloud-computing system. The cloud-computing system may receive the print request and generate print data representing a collage including photos 421, 424, 425, and 429. The collage may then be printed using a printer. Alternatively, the cloud-computing system may send the print data to tablet computer 400 for preview. In that case, the user may indicate that the collage is acceptable and cause the collage to be printed. Accordingly, a user may simply and easily create and print a collage of photos. In one example, the user application may also facilitate the creation of the collage. For instance, the user application may provide the canvas on which multiple photos may be dropped and arranged. Then, the user may cause the image data and event data to be sent to a cloud-computing system via a print button.

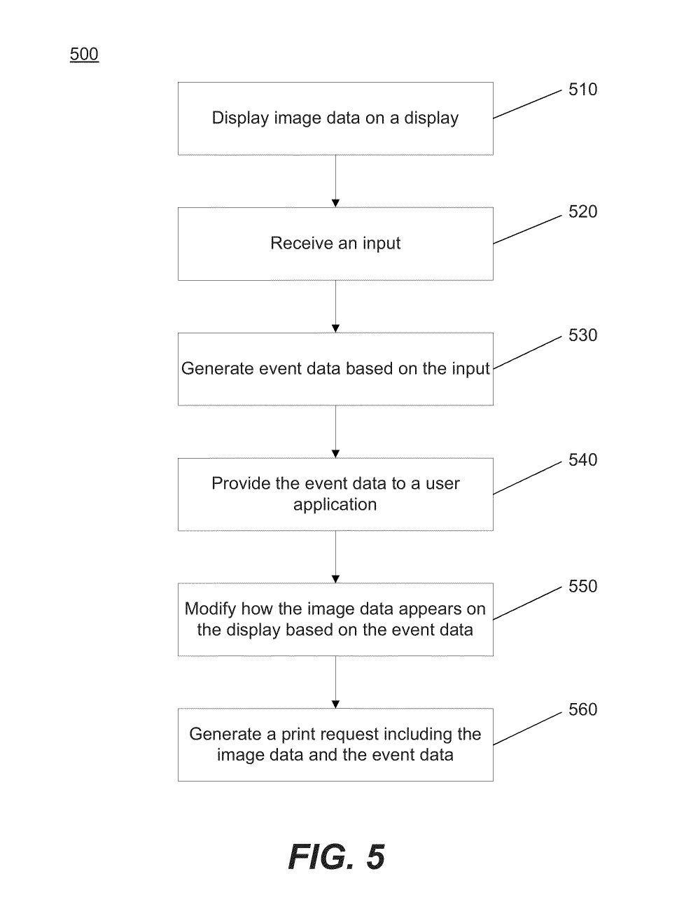

FIG. 5 is a flowchart illustrating aspects of a method 500 executed by a computing device for generating a print request, according to an example. Although execution of method 500 is described below with reference to the components of computing device 100, other suitable components for execution of method 500 can be used. Method 500 may be implemented in the form of executable instructions stored on a machine-readable medium or in the form of electronic circuitry. A processor, a machine-readable storage medium, other control logic, or a combination thereof can be used to execute method 500.

Method 500 may start at 510 where image data may be displayed on a display. For example, image data associated with user application 132 may be displayed on display 110 of computing device 100. At 520, an input may be received. The input may be any of various types of inputs. For example, the input may be a user input received via computing device 100. For instance, the input may be a rotation of computing device 100 from one orientation (e.g., portrait orientation) to another orientation (e.g., landscape orientation). The input may also be a gesture input via a touch interface. For instance, the input may be a pinch-to-zoom multi-touch gesture or a drag-and-drop gesture. The input may be directed to a user application running on a computing device, such as user application 132.

At 530, event data may be generated based on the input. For example, the event data may be generated by a computer program running on computing device 100, such as an operating system. The event data may be generated in conjunction with an input device, such as the touch interface or an accelerometer used to detect orientation of the computing device 100. At 540, the event data may be provided to a user application. For example, the event data may be provided to user application 132.

At 550, the image data displayed on the display may be modified based on the event data. The image data may be modified so that it appears differently. For example, if the input was an orientation change, the image data may be modified so that it appears in the new orientation. As another example, if the input was a pinch-to-zoom gesture, the image data may be modified so that only a zoomed-in portion of the image data appears on the display. The user application may make the modification to the displayed image data. For example, the user application may instruct/request display 110, a display driver, and/or an operating system running on computing device 100 to make the modification to the displayed image data. The modification to the displayed image data may be made without altering the image data as it is stored in memory in computing device 100.

At 560, a print request may be generated. The print request may include the image data and the event data. The image data included in the print request may be the image data unaltered as a result of the event data. The print request may be generated by a print application. For example, print application 134 running on computing device 100 may generate the print request. The print request may be generated in response to an input instructing a print operation. For instance, a user may instruct a print operation by pressing a virtual print button.

In some examples, the print request may be sent to a computer via a communication interface. The communication interface may be similar to the communication interface described with respect to computing device 100. The computer may be part of a cloud printing system. The computer may process the print request and generate print data. For example, the computer may generate print data based on the image data modified in accordance with the event data. The computer may send the generated print data to a printer for printing. In some examples, the computer may first send the print data back to computing device 100 for preview.

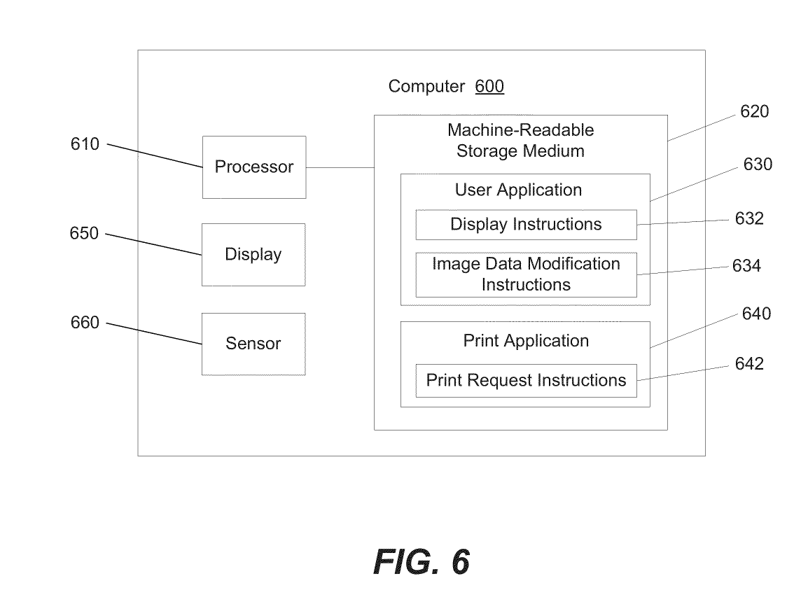

FIG. 6 is a block diagram illustrating aspects of a computer 600 including a machine-readable storage medium 620 encoded with instructions. Computer 600 may be, for example, a tablet computer, a slate computer, a laptop computer, a desktop computer, a smart phone, a personal digital assistant, or the like.

Processor 610 may be at least one central processing unit (CPU), at least one semiconductor-based microprocessor, at least one digital signal processor (DSP) such as a digital image processing unit, other hardware devices or processing elements suitable to retrieve and execute instructions stored in machine-readable storage medium 620, or combinations thereof. Processor 610 can include single or multiple cores on a chip, multiple cores across multiple chips, multiple cores across multiple devices, or combinations thereof. Processor 610 may implement user application 630 and print application 640 and may fetch, decode, and execute instructions 632, 634, 642. As an alternative or in addition to retrieving and executing instructions, processor 610 may include at least one integrated circuit (IC), other control logic, other electronic circuits, or combinations thereof that include a number of electronic components for performing the functionality of instructions 632, 634, 642. Accordingly, processor 610 may be implemented across multiple processing units and instructions 632, 634, 642 may be implemented by different processing units in different areas of computer 600.

Machine-readable storage medium 620 may be any electronic, magnetic, optical, or other physical storage device that contains or stores executable instructions. Thus, the machine-readable storage medium may comprise, for example, various Random Access Memory (RAM), Read Only Memory (ROM), flash memory, and combinations thereof. For example, the machine-readable medium may include a Non-Volatile Random Access Memory (NVRAM), an Electrically Erasable Programmable Read-Only Memory (EEPROM), a storage drive, a NAND flash memory, and the like. Further, the machine-readable storage medium 620 can be computer-readable and non-transitory. Machine-readable storage medium 620 may be encoded with a series of executable instructions.

The instructions 632, 634, 642, when executed by processor 610 (e.g., via one processing element or multiple processing elements of the processor) can cause processor 610 to perform processes, for example, the process depicted in FIG. 5. Furthermore, computer 600 may be similar to computing device 100 and may have similar functionality and be used in similar ways, as described above.

User application 630 and print application 640 may be implemented by computer 600. Display instructions 632 may cause processor 610 to display image data on display 650. Display 650 may be any of various displays, similar to display 110. User application 630 may receive event data based on a user input received at sensor 660. Sensor 660 may be any of various sensors, similar to sensor 120. The event data may correspond to various events. For example, the event data may correspond to a zoom-in event (such as a pinch-to-zoom multi-touch gesture), an orientation change event (such as a rotation of computer 600), or a collage creation event (such as a drag-and-drop of multiple photos on a canvas). Image data modification instructions 634 may cause processor 610 to modify the displayed image data based on the event data. For example, if the event data corresponds to a zoom event, processor 610 may cause display 650 to display a zoomed-in portion of the image data. Print request instructions 642 may cause processor 610 to send a print request to another computer. The another computer may be a computer in a cloud-computing system. The print request may include the original image data and the event data. The print request may be a request to generate print data representing the original image data modified based on the event data. The another computer may generate print data as requested and send it to a printer for printing.

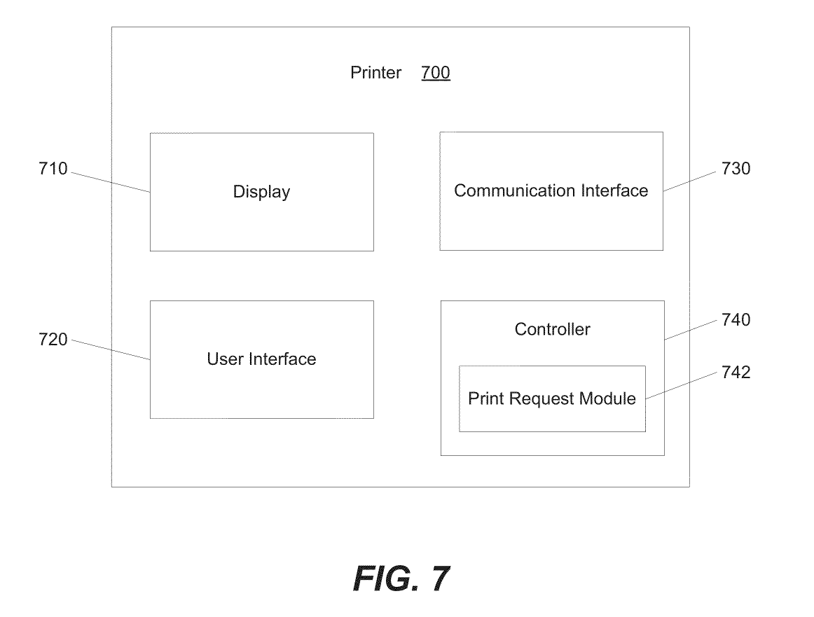

FIG. 7 is a block diagram illustrating an embodiment of a printer 700 including a display 710, a user interface 720, a communication interface 730, and a controller 740. Printer 700 may be a cloud-enabled printer. Accordingly, for example, printer 700 may be capable of receiving print requests and print data from server computers on the Internet. Printer 700 may also send print requests to server computers for processing.

Printer 700 may include a display 710. Display 710 may be any of various displays. For example, display 710 may be a touch-screen display and may thus be combined with user interface 720. Display 710 may display first print data received from a computer. The first print data may be received via communication interface 730. Communication interface 730 may be similar to the communication interface described with respect to computing device 100. The first print data may be received from a computer in a cloud-computing system, such as a server computer. The first print data may also be received from a computer or computing device connected directly to printer 700. User interface 720 may accept multi-touch input from a user. For instance, user interface 720 may include one or more touch sensors. The input may be any of various multi-touch inputs, such as a pinch-to-zoom input. Event data may be generated based on the multi-touch input. For example, if the input is a pinch-to-zoom input gesture, the event data may include coordinates representing a portion of the first print data to be zoomed.

Controller 740 may implement print request module 742 to generate a print request including the event data. The print request may be sent to a computer via the communication interface. The computer that the print request is sent to may be a computer that is part of a cloud-computing system and that is capable of processing the event data. In some cases, the print request may include the first print data, such as when the first print data was received from a computer directly connected to printer 700. In other cases, the print request may not include the first print data, such as when the first print data was received from the cloud computer to which the print request is being sent. In that case, the cloud computer may already have the first print data. In either case, the cloud computer may process the event data and generate second print data corresponding to the first print data as modified in accordance with the event data. For example, if the event data corresponds to a pinch-to-zoom input, the second print data may represent the associated zoomed-in portion of the first print data.

Printer 700 may receive the second print data from the computer. Printer 700 may then print the second print data. In some examples, printer 700 may display the second print data on display 710 to provide a preview of the modified print data to a user before printing. In that case, the user interface may be configured to receive a print command from the user so that the user may cause the second print data to be printed after reviewing it.

What is claimed is:

1. A computing device comprising:
a memory to store a user application and a print application;
a display to display original image data from the user application;
a sensor to receive an input for the user application from a user and generate event data for the user application based on the input; and
a controller to execute the user application and the print application,
the user application configured to make a modification to the displayed image data based on the event data, and
the print application configured to send via a communication interface a print request to another computer, the print request comprising the original image data and the event data for the user application.

2. The computing device of claim 1, wherein the print request is a request for generation of print data representing the original image data with the modification.

3. The computing device of claim 2, wherein the print application is configured to send the print request to the another computer in response to a print instruction from the user, the print instruction not including any settings input by the user relating to the modification.

4. The computing device of claim 1, wherein the event data for the user application represents a change of orientation of the computing device and the modification comprises a change of orientation of the displayed image data.

5. The computing device of claim 1, wherein the event data for the user application represents a zoom-in multi-touch gesture and the modification comprises zooming in on a portion of the displayed image data.

6. The computing device of claim 1, wherein the event data for the user application comprises coordinates and the modification comprises zooming in on a portion of the original image data defined by the coordinates.

7. The computing device of claim 1, wherein the computing device is a tablet computer or a smart phone.

8. A method comprising:
displaying image data on a display of a computing device;
receiving an input via the computing device;
generating event data associated with the input;
providing the event data to a user application executed by the computing device, the user application modifying how the image data appears on the display based on the event data;
generating a print request comprising the image data and the event data.

9. The method of claim 8, wherein the print request is generated by a print application executed by the computing device in response to a second input instructing a print operation.

10. The method of claim 8, further comprising sending the print request to a computer via a communication interface.

11. The method of claim 10, wherein the computer is part of a cloud printing system.

12. The method of claim 8, wherein the input comprises a rotation of the computing device from a first orientation to a second orientation.

13. The method of claim 8, wherein the input comprises a pinch-to-zoom gesture received via a touch user interface.

14. A non-transitory machine-readable storage medium encoded with instructions executable by a processor of a computer, the machine-readable medium comprising:
a user application; and
a print application,
the user application comprising instructions to:
display original image data on a display,
receive event data based on a user input received at a sensor, and
modify the displayed image data based on the event data,
the print application comprising instructions to send a print request to another computer, the print request comprising the original image data and the event data.

15. The machine-readable medium, wherein the print request is a request for generation of print data representing the original image data modified based on the event data.

16. A printer comprising:
a display to display first print data received from a computer:
a user interface to accept multi-touch input from a user and generate event data based on the multi-touch input; and
a communication interface to send a print request comprising the event data to the computer and receive from the computer second print data generated based on the event data.

17. The printer of claim 16, wherein:
the display configured to display the second print data, and
the user interface configured to accept an input from the user instructing the printer to print the second print data.

18. The printer of claim 16, wherein the multi-touch input comprises a zoom-in gesture and the second print data comprises a zoomed-in portion of the first print data.

19. The printer of claim 18, wherein the event data comprises coordinates relative to the first print data.
